(19) United States
(12) Patent Application Publication
(10) Pub. No.: US 2026/0271965 A1
(43) Pub. Date: Sep. 17, 2026

(54) METHOD FOR PRODUCING A TEXTURATE AND EXTRUDER ASSEMBLY

(71) Applicant: NEXNOA GMBH, Karlsruhe (DE)

(72) Inventor: Azad Emin, Karlsruhe (DE)

(73) Assignee: NEXNOA GMBH, Karlsruhe (DE)

(21) Appl. No.: 19/163,566

(22) PCT Filed: Mar. 8, 2024
(86) PCT No.: PCT/EP2024/056289

§ 371 Date: Sep. 9, 2025

(30) Foreign Application Priority Data
Mar. 10, 2023 (DE) 10 2023 106 026.0

(51) Int. Cl. A23J 3/22; A23J 3/26; A23P 30/20

(52) U.S. Cl. CPC A23J 3/227; A23J 3/26; A23P 30/20

(57) ABSTRACT

The present disclosure relates to a method for producing a textured material, in which a protein mixture comprising at least a first protein mixture, in particular a pea protein mixture or a fava bean protein mixture, at a proportion by weight of between 45% by weight and 75% by weight based on a base mixture is provided. Water is supplied at a proportion by weight of between 25% by weight and 50% by weight based on the base mixture to shape a dough and the dough is then extruded at a maximum temperature of between 110° C. and 160° C. to form an extrudate. The extrudate is elongationally shaped at a temperature of higher than 100° C. by propulsion of the extrudate through an elongation die, the geometry of which changes over the length in such a way that a longitudinal and/or transverse elongational stress is produced on the material.

### CROSS REFERENCE TO RELATED APPLICATIONS

The present application is a U.S. National Phase application of PCT/EP2024/056289 filed on Mar. 8, 2024, which in turn claims the priority of German patent application DE 102023106026.0 of 10 Mar. 2023, the entire disclosure of each are hereby incorporated by reference in their entirety.

### TECHNICAL FIELD

The present disclosure relates to a method for producing a textured material and to an extruder arrangement.

### BACKGROUND

Vegetable proteins in the form of isolates or concentrates are nowadays being used for a multitude of meat substitute products. The reasons for this are, firstly, an increased demand for vegetarian or vegan food and, secondly, the consumer demand for sustainable and resource-efficient agriculture.

One of the advantages of vegan food products made from vegetable proteins is that they can be produced from domestically or locally prepared basic materials. Especially legumes, but also other plant matter, are advantageous over soy or other matter in that they can be cultivated more resource-efficiently. On the other hand, there is a growing demand for different plant-based food products.

Products based on vegetable proteins are conventionally manufactured by dry extrusion or high-moisture extrusion. Dry extrusion is carried out at high temperatures T>130° C. and a moisture content <30%. The extrusion is achieved by using a short, narrow die without cooling. This allows the manufacture of direct-expanded products, known as TVPs (textured vegetable proteins). In dry form, they tend to be irregular, porous and glassy and they are further processed into the end products following their rehydration. The end product has a spongy structure without any appreciable anisotropy, with either no fibers or only very short fibers. They have only little resemblance to the sensory properties of meat analogs and are frequently used in mixed products (e.g., burger patties, etc.) and not for whole products.

Such a dry extrusion method for preparing TVP is disclosed in document WO 2021/250 252 A1.

High-moisture extrusion (HME) is the current technology used by industry for manufacturing vegetable protein-based fibrous products. The resulting products often provide a satisfactory base, since they have an anisotropic, meat-like structure, texture and appearance.

In such high-moisture extrusion, the material following kneading is, inter alia, pressed through an elongated slit cooling die or an extended Couette cooling die. In both cases, the protein-based composition is extruded in the screw part of the extruder at relatively high temperatures (T>130° C.) and high water contents (>50%) and then forced to flow through a downstream cooling die in which the material is continuously cooled (typically to below <100° C. at the die exit) in order to avoid any expansion that might destroy the fibrous structures produced in the die part.

Such high-moisture extrusions methods are disclosed, for example, in documents WO 2022/135 732 A1, EP 3 782 475 A1, US 2022/030 911 A1 and WO 2023/275 304 A1.

Although this technique can be used with different plant-based raw materials in order to produce protein-based fibrous products that resemble meat products acceptably on the outside and, in some cases, in taste as well, they lack either long fibrous structures or the desired tenderness, both of which are necessary for successful imitation of the properties of cooked meat.

It was found that the resulting products have fiber-like structures of only short length, whereas real meat consists of long fibers of up to 30 centimetres (cm) in length. Depending on what is implemented, the length of the fibers in the case of vegetable proteins can be increased somewhat, but the resulting end product is very compact and hard and has very high elasticity, which does not lead to the desired mouthfeel of meat products.

There is a need to make further changes to conventional technologies at this point in order to thereby achieve improvements in the products.

### SUMMARY

This need is taken into account by the subject matter of the independent claims. Developments and embodiments of the proposed principle are specified in the dependent claims.

In previous research, it was believed that the fiber formation in the shaping part and the exit die results from the multiphase gelation at high temperatures and the subsequent shaping of this multiphase system through shear stresses in the shaping part, the material being cooled to below 100° C. in order to avoid destruction of the fibers.

Although this technique was found to be successful for manufacturing protein-based fibrous products that typically resemble meat products, it remains a challenge to control the resulting fiber formation. They require precise control of gelation, cooling and shear forces in the shaping part, which in turn vary to a high degree, since such highly elastic materials exhibit a wall slip and melt fracture phenomenon that considerably influences shaping history. Wall slip or melt fracture lead to a sudden pressure drop in the die and thus to expansion of the material, and not only to tearing of the fibers but also to unstable behavior.

As a result, many meat products, especially those having long fibrous structures, cannot be adequately imitated using this technology. They can produce fibrous structures having a parabolic shape (owing to the shear flow) and a relatively short length, whereas real meat consists of longitudinal fibers of up to 30 cm in length.

In addition, the die technologies available only allow the texturing of protein-based compositions having very specific properties. Typically, the appropriate protein sources should have very high gel strength and viscosity after treatment in the screw section of the extruder, since this significantly influences the shear stresses in the die section (low viscosity, low shaping stresses, lack of fiber formation). This limits the use of many protein resources that might be cheaper, more sustainable or healthier.

### Definition of Protein Mixture

For the purpose of this application, the term protein mixture□ means a vegetable protein mixture. Such a vegetable protein mixture is generally obtained from a single plant species in the preparation process, though a small amount of contamination from other plants may be found.

Unless stated otherwise, a □vegetable protein□ comprises a vegetable protein mixture from the plant in question; if this is not so, it is called an □individual plant protein□. Besides the actual vegetable proteins, the mixture may contain further constituents as well, such as starch, sugar, fibrous materials, minerals, fats and oils. Likewise, individual amino acids may be components of the protein mixture. Details of the respective amounts will be given below in relation to the terms □concentrate□ and □isolate□.

Accordingly, a □pea protein□ or a pea-based vegetable protein is a protein mixture which substantially comprises pea, pea constituents or proteins of the pea plant and has been processed accordingly.

A protein mixture can be obtained as such from the plant species, but can also be the result of a by-product. There are also various byproducts, press cakes and residues which can be utilized as a protein source and thus constitute protein mixtures within the meaning of this definition. Without providing an exhaustive list, these include residues from sugar production or from the production of alcoholic beverages such as beer and wine, residues and by-products from oil production, such as soybean oil, coconut oil and rapeseed oil, or from plant milk production, such as oat milk, pea milk or fava bean milk. Further examples of various by-products from which protein mixtures can be produced or contain them include okara (soy pulp), almond pulp, oat pulp, coconut pulp/flesh, sunflower cake, rapeseed cake, flaxseed flour, hemp cake, cashew residues and groundnut cake and corn gluten flour, whey protein, casein micelles, potato juice, chickpea pulp, lentil residues, spent brewerls yeast and spent malt (draff).

Further vegetable proteins which can be processed either in the form of a concentrate or isolate (see the relevant definitions) or in some other form as protein mixtures include (without being an exhaustive list) textured soy protein, tempeh, hydrolyzed wheat protein, mycoprotein (fungal mycelium, for example from Fusarium venenatum), rice protein, potato protein, corn protein (zein protein), hemp protein, seaweed protein, for example from Spirulina or Chlorella, rapeseed protein, sunflower protein, cotton seed protein, pumpkin seed protein, quinoa protein, amaranth protein, millet protein, spelt protein, oat protein, barley protein, Lemna protein, manioc protein, coconut protein, macadamia protein, cashew protein, chia protein, flaxseed protein, sacha inchi protein, watermelon seed protein, pistachio protein and yeast protein.

The aforementioned proteins can in turn be divided into legume proteins and non-legume proteins. Depending on the textured material desired, legume protein mixtures can be combined with non-legume protein mixtures and processed by the presented method.

### Definition of Legume Protein

A legume protein is a protein mixture which is obtained from legumes. They include pea and fava bean, but also lentil, mung bean, chickpea, white kidney bean and groundnuts. They also include soy; however, even though the cultivation of soybeans consumes distinctly more resources in relation to other legumes, soy shall also be covered by the term “legume protein” unless explicitly stated.

### Definition of Non-Legume Protein

A non-legume protein is a protein mixture which comprises vegetable proteins, but which does not originate from a legume. They are thus obtained from other crops which are not listed as legumes in the definition above and do not constitute such legumes either. Besides wheat, they also include all other cereals and grain varieties, for example oat, and hemp, potato, rice, hemp, pumpkin seed, corn, but also rapeseed and sunflower. Proteins from seaweed, yeast, fungal mycelium and/or fungal sporocarp are likewise covered by non-legume proteins.

In this connection, protein mixtures from these plants are also referred to as other protein mixtures, and thus differ from protein mixtures made from or containing legumes.

### Definition of Concentrate and Isolate

The terms “vegetable protein isolate” and “vegetable protein concentrate” both describe vegetable protein mixtures which differ in the concentration of the protein content. The other constituents of an isolate or concentrate are, for example, fats and sugar including starch and cellulose, which remain in the mixture when the concentrate or isolate is processed. The individual other constituents are reduced compared to the original concentration; however, residues are still present in the isolate or concentrate in varying concentration because of the different processing options. In addition, a small proportion of residual moisture is also present in the isolate or concentrate.

A plant protein isolate is, for example, a mixture of a plant protein in which the concentration of the protein in the mixture is in the range of above 85% by weight, for example in the range from 87% to 97% by weight. In the case of a plant protein concentrate, the proportion by weight of the vegetable protein is usually in the range below 80% by weight or below 70% by weight, for example in the range of 40% by weight to 75% by weight or to approx. 80% by weight. Moreover, there is a transition range which, depending on the protein mixture, ranges between 75% by weight and 85% by weight and in which, depending on the manufacturer, protein variant or other parameters, is called a concentrate or an isolate.

Depending on the processing and preparation process, a plant species can thus yield a plant protein concentrate or plant protein isolate. Thus, the preparation process not only substantially influences the concentration of the vegetable protein mixture, but may also influence the composition of the remaining constituents and the residual moisture.

### Definition of Further Ingredients

In some aspects, at least one further ingredient can produce additional functionality in protein composition, taste, textural composition, or visual or tactile properties. It should be noted here that the abovementioned protein mixtures are mixed from the various crops, not only with respect to the different crops, but also with respect to concentration. One example would be mixtures of pea protein and fava bean protein, but possibly also additives of wheat or rice protein to a protein mixture of soy or pea.

In addition, further ingredients, such as salt, spices, additional starch, sugar, syrup, fats or oils, may also be present. They can be added as part of the raw material at the start; alternatively or additionally, they can also be added during the processing process. Surprisingly, it has been found here that especially sugar, oils and salts, and/or in the form of sugar-, salt- and oil-containing ingredients, such as grape juice concentrate or soy sauce, make it possible to not only adjust taste but also modify texture. These additional constituents may be in free form, but may also be bound in relevant raw materials in highly concentrated form, for example sugar in syrup.

A further option is that of supplying functional constituents, such as flavorings, and/or additional protein/amino acid sources in order to set specific properties or improve biocompatibility in humans. In general, the additional mixtures and one or more of the abovementioned substances are referred to as further ingredients or further components.

### Definition of Base Mixture

A base mixture is a combination of a protein mixture, be it from one plant species or mixtures of multiple plant species, as plant protein isolate, plant protein concentrate or a combination thereof, and water, which is added before or during processing. Optionally, further protein mixtures and/or at least one other ingredient and/or at least one other component can be added.

When water is added to the mixture thus prepared, it forms a dough which is then further processed in an extruder. Alternatively, the individual constituents can also be fed to the extruder during extrusion.

The base mixture is generally specified in percent (%) by weight, based in each case on the weight of all the ingredients added. A base mixture composed of 50% by weight of protein mixture and 50% by weight of water is thus produced by mixing the same proportions by weight of the protein mixture and water. Nevertheless, the total water content in the base mixture is somewhat greater than 50% because the protein mixture itself contains some residual moisture. The same applies to salts, sugar and fats added to the base mixture, since they are also present in differing amounts in the protein mixture.

Accordingly, the individual constituents in the base mixture are thus shifted somewhat in relation to the proportions added. This is also the case with regard to the water content, which, in the dough, is usually somewhat higher than the water purely added owing to the residual moisture in the protein mixture; however, the water content can be lower again in the finished textured material owing to the evaporation of some water.

### Definition of Extrudate

In the following, extrudate or viscous or highly viscous material refers to the dough material which is produced in the extruder, such as by kneading, and which is subsequently elongationally shaped. The textured material then corresponds to the finished extrudate which has been elongationally shaped and processed in some other way.

### Definition of Fiber

Fibers in the context of this application are elastic, cohesive layers that are oriented along a main direction referred to as the fiber direction. Fibers in the context of this application exhibit strong anisotropy, which may mean that they can be detached or separated from the rest of the product when the fibers are pulled in a direction different from their fiber direction (e.g., from the transverse direction if they are oriented the longitudinal direction, or vice versa). The fibers are thus relatively loose or detachable when they are pulled in a direction orthogonal to the fiber direction, and elastic and cohesive when they are pulled along the fiber direction. By simply pulling by hand, individual fibers can be detached from the product.

Fiber length refers to the maximum length of the layer that is detached from the product without tearing while retaining its strong anisotropy and elasticity in the fiber direction. The average fiber length is usually smaller and follows a normal distribution. Unless stated otherwise, fiber length predominantly means average fiber length.

### Definition of Thermomechanical Treatment

A process during extrusion in which the dough is exposed to a specific temperature range while it is being mechanically processed. Mechanical processing can include kneading, rolling, milling, compressing and other forms in which a force or torque is exerted on the dough.

### Definition of Axial and Transverse Elongation

The shaping of the material along the longitudinal axis (axial) and/or lateral axis (transverse) that occurs in a channel of a die mounted downstream of the screw portion of the extruder. The material is pulled apart along the respective axis. If the elongation is effected downstream of the exit of the extruder, the extrudate is elongated accordingly.

### Definition of Material Temperature

The temperature reached by the protein mixture during the thermomechanical treatment in extrusion. Unless stated otherwise, the specified temperatures refer to the material temperature.

The inventor has recognized that elongational stresses occurring in the processing of vegetable proteins are more efficient in shaping than shear forces. Appropriate control of when these forces occur and how strong they are allows the production of fibrous structures in protein mixtures that are not sufficiently textured in conventional systems owing to insufficient shaping of the composition. Specifically, it is proposed to take advantage of strong longitudinal and/or transverse elongational stresses, based on the extrusion direction, in order to produce fibrous structures in vegetable protein-based extrudates at both medium (<50%) and low (<30%) moisture content. The proposed principle makes it possible to adjust the anisotropy of the textured material, in contrast to conventional techniques, and so it is possible to apply the technique to all types of protein sources and mixtures thereof. Accordingly, average fiber lengths of 1 cm to 30 cm can be produced for example.

By adjusting the viscoelasticity, for example by a suitable selection of ingredients, and/or the shaping stresses during the individual processes, even protein mixtures that are otherwise non-texturable or difficult to texture can be textured. This creates a basis for texturing a broad spectrum of proteins (including concentrates), and the texture can be configured according to the requirements of the end product. For instance, vegan products resembling fish, chicken, beef or pork in texture and taste can be realized.

The proposed method is based on a combination of a base mixture composed of one or more protein mixtures and also secondary components and water, which is extruded at a dry to medium moisture content (10% by weight to approx. 40% by weight) and at quite high material temperatures. The textured material is prepared by using a specifically shaped die without cooling for producing continuous elongational shaping that leads to the fiber formation according to the present disclosure. The use of the elongation-dominated flow or, more precisely, sliding produces a longitudinal or transverse velocity component of the hot material in the die owing to a varying shape and/or a decreasing cross-section. The use of various materials as wall material makes it possible to adjust the contribution of shear stresses, which in some cases can be reduced almost to zero by using a PTFE or ceramic wall. Stainless steel in this respect has a significantly higher coefficient of friction, meaning that there is a risk of wall adherence, thus resulting in a fracture in the fibers, which leads to short fibers. To allow sliding here, it is appropriate to further increase the viscosity of the material.

This reduces the risk of flow instabilities in the die and allows a very well defined deformation by longitudinal and/or transverse elongation of the extrudate. As a result, especially the die geometry can produce both longitudinal and transverse elongational stresses. The term “longitudinal elongational stress” is understood to mean an elongational stress substantially parallel to the direction of propulsion. A transverse elongation is an elongation mainly perpendicular or transverse to the direction of propulsion of the extrudate.

Moreover, in some aspects, the temperature is above 100° C. and the pressure inside the die is likewise greater than 5 bar and also greater than 10 bar in this process. The resultant textured material has a meat-like quality due to a fibrous structure having a length of greater than 8 cm and in particular greater than 12 cm and also up to 30 cm. The water content of the textured material is in the range of less than 40% by weight, in particular less than 30% by weight.

Formed at the exit of the elongation die is a direct-expanded textured material which can be used, after rehydration or after milling, to cause collapse of the pores and to produce compact fibrous end products.

In this way, not only can different protein mixtures be textured, but it has also been found that, surprisingly, use can be made of protein mixtures that are unable to be textured to form long fibers or a long-fiber meat-like structure under normal conditions. Through further processing, the fibrous structure of the textured material can then be matched to a desired end product.

Under conventional manufacturing techniques by contrast, the expansion would destroy the fibrous structures, but here, the resulting product structure is highly stable owing to the formation of long fibers and to the high viscoelasticity; the evaporation and expansion at the exit of the elongation die leads only to a loose and tender product, but with an intact fibrous structure.

The type of elongational stresses, i.e., longitudinal and/or transverse stresses, can be determined by the die geometry. The extent of the longitudinal and/or transverse elongational stresses can be adjusted by varying the wall material (PTFE, ceramic or stainless steel) and by varying the design parameters listed in this application. This also includes the shape of the entry cross-section, the shape of the exit cross-section and the transition thereto. In this way, the nature and strength of the elongational stress can be adjusted, thus also allowing texturing of protein mixtures that are otherwise difficult to produce.

In the method for producing a textured material, a base mixture comprising a protein mixture is provided. The protein mixture comprises at least a first protein mixture, such as one or more from an oat protein mixture, a wheat protein mixture, a pea protein mixture or a fava bean protein mixture, specifically at a proportion by weight of between 40% by weight and 90% by weight based on a base mixture. Other possible proportions would be 45% by weight, 50% by weight, 55% by weight, 60% by weight, 65% by weight, 70% by weight, 75% by weight and 80% by weight, and especially the respective ranges between two of these aforementioned values, i.e., for example between 45% by weight and 50% by weight, respectively, based on the base mixture.

In some aspects, the base mixture may also receive multiple different protein mixtures, especially vegetable protein mixtures from different plant species. In some aspects, this may include wheat. A second vegetable protein mixture may have, for example, a proportion between 5% by weight and 35% by weight based on the base mixture. Other possible proportions are 10% by weight, 15% by weight, 20% by weight, 25% by weight, 30% by weight, 45% by weight and 50% by weight, and the respective ranges between two of these aforementioned values, i.e., for example between 10% by weight and 15% by weight. In general, the second protein mixture should not have a larger proportion of the base mixture than the first protein mixture.

The proteins may be one of the abovementioned legume proteins, including soy, or a combination thereof. Similarly, mixtures of one or more legume proteins and a further protein mixture, in particular a nonlegume protein mixture, may be used. In addition, these mixtures are in the form of concentrates or in the form of isolates, and so the pure protein content in the textured material is usually somewhat lower.

In the method, water is now added to the protein mixture at a proportion by weight of between 10% by weight and 45% by weight based on the base mixture to form a dough. Other possible proportions of water added are 10% by weight, 15% by weight, 20% by weight, 25% by weight, 30% by weight, 35% by weight and 40% by weight. In some aspects, the protein mixture in the base mixture may also already have an increased residual moisture content. This is taken into account when water is added, such that the dough has a total water content of, in some aspects, less than 50% by weight and in particular less than 45% by weight, less than 40% by weight or less than 35% by weight based on the dough material.

The water may be added before kneading, but it may also be added while the dough is being kneaded and shaped in an extruder. In other words, in some aspects, the base mixture may be introduced into an extruder and the water is supplied separately. In other aspects, the water is partially or completely added to the base mixture and the resultant dough is then added to the extruder for further kneading.

The method further includes the step of extruding the dough at a maximum temperature in the range of between 110° C. to 160° C., but may be between 120° C. and 145° C. The term “extruding” in this respect is understood to mean kneading the dough under an increased pressure and the abovementioned temperature, with the dough usually being kneaded and propelled by one or more screw drives or similarly operating drives. The dough material is thus extruded at a low moisture content of less than 50% by weight (as far as just above 10% by weight), but at the above high temperatures, and so the extrusion can be referred to as dry extrusion or low-moisture extrusion. Owing to the relatively low water content at a medium to low level, the dough material has a highly viscous and highly elastic composition in the screw part of the extruder compared to other manufacturing methods.

The thus highly viscous, but simultaneously highly elastic composition is now elongationally shaped at a temperature of higher than 90° C. and in particular greater than 100° C. This is done by propelling the hot and highly viscous material through a specific elongation die which does not require extra cooling. The specific elongation die is characterized in that an area of its entry cross-section is greater than an area of its exit cross-section also a length is distinctly greater than a maximum diameter of the entry cross-section, or in that a diameter in one direction differs from a diameter in another direction between entry and exit.

According to the proposed principle, the elongational shaping discussed above is effected either in the longitudinal direction, i.e., along the direction of propulsion, and/or in a transverse direction, i.e., transverse to the direction of propulsion. This is also called a longitudinal elongation or a transverse elongation; a transverse elongation can be effected in two directions. A combination of such elongations can be adjusted, for example, through the above-mentioned parameters, including by suitably choosing the wall material and the die geometry. The elongational stresses are effected, inter alia, by sliding of the extrudate along the wall, such that little or no shear flows are formed. Here, it should also be emphasized in particular that the viscosity of the highly viscous material should not become excessively low, otherwise the required elongations cannot be produced.

In this way, long continuous fibers resembling a meat structure are produced in the extrudate owing to the temperature that remains increased, in particular above the evaporation temperature of water, and the pressure present by continuous elongational shaping and the elongational stresses that occur. The elongationally shaped extrudate leaves the die as textured material, and, in some aspects, the temperature and pressure suddenly drops. Owing to a distribution that is not necessarily homogeneous, the expansion leads to a localized phase relatively rich in water (also referred to as the soft phase), thereby creating the anisotropy according to the present disclosure. As a result of evaporation, these soft phases relatively rich in water become even “looser”.

In some aspects, the supplied protein mixture and water is kneaded at a rising temperature up to the maximum temperature. The maximum temperature can also be maintained while the dough is being further kneaded. In some aspects, the temperature rise and the pressure rise are effected continuously, but they may also be effected discontinuously, i.e., with sections of propulsion in which further heating does not occur. The transition from a paste (usually a relatively high water content) to a dough is fluid, the latter in particular being a kneaded and mechanically difficult to separate material composed of the components of base mixture and water.

In some aspects, the maximum temperature is in the range from 110° C. to 160° C. and in some aspects may be between 115° C. and 135° C., and/or between 120° C. and 145° C. Other temperature ranges for the maximum temperature would be 112° C., 114° C., 116° C., 118° C., 120° C., 122° C., 124° C., 126° C., 128° C., 130° C., 132° C., 134° C., 136° C., 138° C., 140° C., 142° C., 144° C., 146° C., 148° C., 152° C. and 154° C. The temperature may be increased continuously to the maximum temperature during the kneading and propulsion of the dough or material and then kept constant. In some aspects, the temperature rise is configured in such a way that the maximum temperature is reached after approx. halfway along an extruder stretch. Similarly, the temperature may be changed multiple times during propulsion during kneading, such that different temperatures are set sectionally. Similarly, the pressure increases to a maximum value during kneading and extruding. Accordingly, in some aspects, extruding is effected at a pressure in the range from 1 bar up to 100 bar or above. Typical ranges are between 20 bar and 80 bar and in particular below 60 bar at the end of the extruder.

Varying the thermal stress profile during extrusion varies the degree of protein-protein interactions and polymerization reactions, which allows broad adjustment of elasticity and viscosity. This aspect is brought about not only in the extruder itself (i.e., during kneading of the dough), but also to a lesser extent during elongational shaping as well.

In some further aspects, a gas is added during kneading, i.e., in the screw part of the extruder, in order to thus loosen up the dough and also the later extrudate. The gas may be added at one point in the screw part of the extruder, for example in the starting region of the extruder, but may also be added at various points. In some aspects, the gas is added at a pressure that is additionally increased later during extrusion, such as in the screw part. As a result, the gas becomes “dissolved” in the material of the extrudate and remains bound in the material. The pressure becomes lower again only on later elongational shaping and especially at the end on exit of the textured material, such that the gas contributes to loosening up the extrudate. For this purpose, the gas used may be carbon dioxide, nitrogen and, in some cases, even air.

In some cases, a gas-producing material may also be added to the dough, said gas-producing material decomposing on further processing, i.e., during the kneading operation in the extruder, thus contributing to gas formation. A typical material of this kind is sodium bicarbonate (sodium hydrogencarbonate), which decomposes with citrates or other weak acids to form carbon dioxide. Both substances may be added to the base mixture at the start as dry materials and only begin to react when water is added. If water is added in the screw part of the extruder, the gas is also prevented from escaping prematurely. In some aspects, what is also added is sodium bicarbonate only, which is decomposed to carbon dioxide and sodium carbonate again during kneading owing to the high temperature.

In the proposed method, the elongation die is not actively cooled, i.e., the elongationally shaped textured material leaves the elongation die at a temperature greater than 100° C. Similarly, elongational shaping may be effected at different temperatures, such that elongational shaping in some aspects is divided into multiple steps, individual steps of which are carried out at different temperatures above 100° C.

During elongational shaping, the flow velocity is increased, but the mass flow rate remains substantially unchanged. In the case of a longitudinal elongation, the change in flow velocity occurs along the direction of propulsion, and in the case of a transverse elongation, it occurs perpendicularly thereto, i.e., the viscous material is elongated along a direction transverse to the direction of propulsion. This elongation may be effected, for example, by sectionally effecting transverse elongational shaping at temperatures of higher than 100° C. by propulsion of the highly viscous material, such that a flow velocity is increased in a direction perpendicular to the direction of propulsion. Alternatively, what may also be carried out is sectional longitudinal elongational shaping at temperatures of higher than 100° C. by propulsion of the highly viscous material, such that a flow velocity is increased in a direction along the direction of propulsion.

Similarly, it is possible that a propulsion velocity is at least in some cases lower than a flow velocity in a direction perpendicular to the direction of propulsion. Thus, the material is, for example, widened more quickly than propelled in some sections. In some aspects, elongation can be influenced by coating the wall, decreasing the diameter of the elongation die or reducing height in relation to width, and other parameters. The mass flow rate remains substantially constant and, owing to the high viscosity, laminar as well. In order to avoid breaking of the elongational stresses, it is convenient to minimize the static friction between the material and the wall, such that the material slides therealong. As a result of propulsion of the extrudate, the material is elongationally shaped at temperatures of greater than 100° and may be between 105° C. and 115 C.°. At the end of this elongational shaping, the temperature of the product in some aspects is still above 100° C. and is, for example, in the range between 110° C. and 135° C. In specific aspects, it may even be above 130° C.

Longitudinal or transverse elongational shaping may be effected continuously, but also sectionally. In the first case, this is achieved, for example, by continuously decreasing the cross-sectional area. In some aspects, instead of the cross-section, a width-to-height ratio of the entry and exit is related, with the ratio likewise varying. In aspects, one of the two variables is reduced between the entry and the exit. Thus, this allows specific production of transverse flows and elongations.

In the cases mentioned, this means that the flow velocity of the material is increased sectionally, followed by one or more sections in which the flow velocity is substantially constant. Here, the increase in flow velocity can occur along the direction of propulsion of the material, but also perpendicular thereto. Alternatively, the flow of may be increased continuously, such that elongational shaping is effected over a relatively long section, possibly even up to the exit of the elongation die. In some aspects, a transverse flow velocity (i.e., perpendicular to the propulsion flow direction) is determined by the ratio of the width of the entry to the width of the exit. Accordingly, the die may also be short, provided that transverse elongational stresses are produced in particular.

In some aspects, the time with which the material is propelled in sections of constant flow velocity is greater than the time in which the material is forwarded at increasing flow velocity.

Owing to the low water content in the dough, its viscosity is increased compared to extrudates having a higher water content. The increased viscosity leads to greater elongational stresses owing to the differences between the entry cross-section and the exit cross-section. The length of the die also plays a part. This is helpful in the aspects presented herein for influencing the mass flow rate through the shape, length and design of the elongation die. According to the present disclosure, a length of the die through which the viscous material is propelled is greater by at least a factor of 3 to 7 than the maximum diameter of the entry cross-section, or the greatest extent of the entry. To produce transverse elongational shaping of the viscous material, the length in a first direction perpendicular to the length of the die, width, is varied, for example increased, over the length of the die, whereas the length in the direction perpendicular to the first direction and perpendicular to the length of the die is reduced over the length of the die. If, at the same time, the exit cross-section is also additionally reduced compared to the entry cross-section, the result is not only transverse elongations, but also longitudinal elongations.

Accordingly, the elongation on the material may also be changed at least in two successive sections during propulsion. This can improve fiber formation. A change in elongation may be achieved, for example, by changing the geometry of the elongation die, but also by changing the coating of the wall of the elongation die. In some aspects, the static and/or dynamic friction acting on the material during propulsion may also be altered, for example achieved by changing the wall materials of the elongation die. In this connection, it is possible to design the sections during propulsion in such a way that longitudinal elongational stresses and transverse elongational stresses act on the viscous material sectionally.

In some aspects, elongational shaping is followed by cooling the textured material to a temperature below 100° C. This may be done by flash relaxation, i.e., by depressurization with simultaneous cooling. The cooling may possibly also only start a little later than the depressurization. Owing to the sudden depressurization, such as close to a temperature of 100° C. than for example 105° C. to 110° C., remaining water within the elongationally shaped composition is suddenly evaporated and, in some aspects, loosening of the textured material occurs.

Some further aspects are concerned with the base mixture. In some aspects, salt is also supplied to the base mixture in order to modify a water distribution in the textured material. Otherwise, moisture will tend to localize in the dispersed phase and will therefore make the continuous phase containing less water harder. In some aspects, the supplied salt content may be up to 2% by weight and in particular up to 1.5% by weight. Likewise or alternatively, sugar may be additionally supplied, i.e., sugar beyond the pre-existing proportions in the protein mixture. In some aspects, the supplied sugar content is up to 15% by weight, this amount in turn being dependent on the protein mixture used. For this purpose, the abovementioned sugars may be used. The supplied sugar is used in order to replace the large, branched and reactive protein molecules with very small sugar molecules, thus reducing network formation. Possible sugars for this purpose would be glucose, fructose, maltose, syrup, sugary fruit juices and others.

Other optional ingredients would also be, for example, oils and fats at up to 10% by weight and flavorings up to 2% by weight or chromophoric ingredients up to 2% by weight. Altogether, the further ingredients are up to 25% by weight, but usually below up to 20% by weight or below.

The combination of additionally supplied sugar and salt and the process parameters such as the temperature during kneading allows the adjustment of the gel strength and bite strength of the composition and thus of the textured material to a desired range.

In downstream aspects, the textured material prepared in this way may be further processed in order to achieve an improvement in the structure. Possible measures for this purpose are not only mechanical aspects, such as cutting, milling, pressing, rolling and the like, but also drying of the intermediate product and also deep-frying or coating. All these measures are used to prepare the final product from the textured material prepared by the proposed method.

Some further aspects concern an extruder arrangement suitable for carrying out the method.

The extruder arrangement includes a mixing extruder comprising an inlet zone for supplying a base mixture, the base mixture containing at least one protein mixture and water and optionally further ingredients according to the above-stated aspects. Furthermore, the mixing extruder includes a mixing zone and an expulsion zone. The mixing extruder is designed to produce a temperature rise over the zones up to a maximum temperature of between 110° C. to 160° C. Furthermore, connected to the expulsion zone of the mixing extruder is an elongation die having a length, an entry cross-section and an exit cross-section. The entry cross-section may correspond to the shape and cross-section of the expulsion zone of the mixing extruder.

According to the proposed principle, an area of the exit cross-section is smaller than an area of the entry cross-section and the length is greater than a maximum extent of the entry cross-section in one direction. Alternatively, it is conceivable to reduce height H to width B between the entry and exit of the die. Similarly, the elongation die is configured to bring about a temperature of the propelled extrudate of higher than 100° C. at the exit of said elongation die. Thus, in the extruder arrangement according to the present disclosure, the extrudate is subjected to longitudinal and/or transverse elongational shaping with proportionally little or no shear stress at the same time, such that targeted and in particular longitudinal or transverse fiber formation commences in plant-based extrudates.

In some aspects, the mixing extruder includes a two-axis screw drive in which the supplied protein mixture and the water are shaped into a dough at rising pressure and temperature. The mixing extruder in some aspects is designed to exert the temperatures and pressures mentioned in the method above. For this purpose, the mixing extruder may contain multiple sections which are arranged one after another and in which heating elements independently operable of one another are arranged. In this way, different temperature profiles can be produced.

In some further aspects, an inside of the elongation die includes a surface composed of a fluoropolymer, such as Teflon, or a ceramic or a glass coating. As a result, in some aspects, the elongation die is designed in such a way that the extrudate slides substantially along an inner surface of the elongation die. Alternatively, what may also be provided is another plastic which is temperature-resistant and at the same time food-approved and which has a different, such as smaller friction or adhesive force, compared to other materials. The surface may be provided with the corresponding plastic; however, it is also possible to make the elongation die from plastics at least sectionally. Accordingly, in some aspects, an inside of a first section of the elongation die may include a first material, and an inside of a subsequent second section of the elongation die may include a second material different from the first material. In a further design, sections of the elongation die differ in static friction.

In contrast to metals, plastics exhibit distinctly lower heat transfer. Accordingly, in some aspects, in sections in which the surface is provided with plastic, a temperature of the propelled material will drop less than in sections having a metallic surface. In particular, the elongation die in some aspects is designed in such a way that the temperature of the propelled material in these sections remains substantially constant. The held temperature may be in some aspects, in the range between 110° C. to 160° C., in some aspects between 115° C. and 135° C., in some aspects between 120° C. and 145° C., in some aspects between 115° C. and 125° C., in some aspects between 110° C. and 120° C., in some aspects between 120° C. and 135° C., in some aspects between 120° C. and 130° C., in some aspects between 125° C. and 135° C. and in some aspects between 130° C. and 140° C.

In some aspects, the maximum temperature in at least one of the zones is in the range between 110° C. to 160° C. and may be between 115° C. and 135° C. and in some aspects between 120° C. and 145° C. Further temperature ranges are between 110° C. and 120° C., 115° C. and 125° C., 120° C. and 130° C. and between 125° C. and 135° C. The temperature ranges in some aspects are dependent on the protein mixture used.

Some aspects concern the shape of the inlet cross-section of the elongation die and the exit cross-section of the die. For instance, the entry cross-section of the elongation die may have the same shape as the exit cross-section. In some aspects, the elongation die is directly connected to the expulsion zone of the extruder, and the cross-sections thereof are identical. However, it is possible to couple the extruder and the elongation die via a short coupling piece, provided that it is distinctly shorter than the elongation die. Such a coupling piece may have different entry and exit cross-sections and connect the extruder and the elongation die to one another in this way. In other aspects, the elongation die has a maximum entry width and a maximum exit width in a first direction in both cases and a maximum entry height and a maximum exit height in a second direction perpendicular to the first direction, with a maximum exit width in the first direction being greater than the maximum entry width in the first direction and the maximum entry width in the second direction being smaller than the maximum exit width in the second direction.

The elongation die in some designs has a continuous decrease or reduction in the area of the entry cross-section in relation to the area of the exit cross-section, or a continuous decrease in the ratio between the entry ratio H_{entry}/B_{entry} and the exit ratio Hₑₓᵢₜ/Bₑₓᵢₜ. In some other aspects, the elongation die includes at least one first section having a constant cross-sectional area, at least one subsequent second section having a decreasing cross-sectional area, and at least one subsequent third section having a constant cross-sectional area. Moreover, a material of a section having a constant cross-sectional area may be different from a material of a section having a decreasing cross-sectional area. In some aspects, as already mentioned, the die becomes thinner and at the same time broader over the length, such that this builds up transverse elongational stresses. Here too, widening may occur sectionally, such that the die includes sections having a constant cross-sectional area or height. The length of the die in some cases may be such that the length ranges between one times and three times the greatest width or height. However, in some aspects, the die and the method are designed in such a way that the die geometry does not lead to a sudden pressure drop, i.e., the volume of the die does not increase suddenly over the length, thus allowing expansion of the material. This avoids fractures.

Furthermore, in some aspects, the at least one first section has the entry cross-sectional area or the entry cross-section and the at least one third section has the exit cross-sectional area or the exit cross-section, a length of the at least one first and/or the at least one second section optionally being greater than the maximum dimension of the entry cross-section or the exit cross-section in one direction. In this connection, there may also be multiple second sections, which in turn may be different, i.e., designed with constant or decreasing sections.

In further aspects, the elongation die is designed with an exit cross-section which, in plan view, has the shape of a circular ring, an inner part surrounded by the circular ring being formed by a body, such as a cone shape, tapering toward the entry cross-section. The term “circular ring” is understood hereinafter to mean not only a circular ring that is completely round (i.e., having a center and constant radius), but also a circular ring having an oval shape or two interlinked circular segments. For simplicity, other shapes, right up to a rectangular or square frame with or without rounded corners, are also intended to be covered by the term “circular ring” for this application.

In another aspect, the elongation die has an exit cross-section which, in plan view, has multiple openings, of identical cross-section, arranged around an inner part, the inner part having a body tapering toward the entry cross-section. The tapering body in these aspects is formed in such a way that a cross-section through the material of the body decreases continuously toward the entry cross-section of the elongation die.

In this connection, for the abovementioned aspects, the inner part may be arranged with a central opening, the cross-section of which is optionally different from the cross-sections of the openings surrounding the inner part.

Lastly, in some aspects, a cooling die or cooling pipe connected to the exit of the elongation die and configured to cool the elongationally shaped textured material to below 100° C. may also be provided.

Further advantages of the method and arrangement presented herein are not only the possibility of being able to adjust the elongational stress through the die geometry, but also the processing of different proteins that were previously difficult to texture. Dry, nonperishable textured materials can be produced that can be further processed in various ways with their long-fiber structure. A further advantage is the more efficient use of energy, since the elongation die, in contrast to conventional manufacturing methods, is not cooled, which also simplifies scalability.

### BRIEF DESCRIPTION OF THE DRAWINGS

Further aspects and embodiments according to the proposed principle will be disclosed in relation to the various embodiments and examples that will be described in detail in conjunction with the accompanying drawings.

FIG. 1 shows a mixing extruder, as can be used for the proposed method and the extruder arrangement according to the proposed principle;

FIG. 2 shows a cross-sectional view of a first embodiment of an elongation die according to the proposed principle;

FIG. 3A shows an elongation die that includes a die body having, on an entry side, a round entry region and, on an exit side, a correspondingly round exit cross-section according to the proposed principle;

FIG. 3B shows the elongation die in which the elongation sections are distinctly extended compared to the rest of the sections according to the proposed principle;

FIG. 4A shows a cross-sectional view that the elongation die has a conical body in an exit region in the form of a cone such that a cone tip thereof ends within the elongation die according to the proposed principle;

FIG. 4B shows a cross-sectional view of that an inside of the elongation die is formed by a tube having a constant cross-section according to the proposed principle;

FIG. 5A shows an entry side of a first section of the elongation die is connected to an expulsion zone of the mixing extruder according to the proposed principle;

FIG. 5B shows the elongation die in which a cone body is replaced by a more complex shape according to the proposed principle;

FIG. 5C shows the elongation die with a square shape in an entry region according to the proposed principle;

FIG. 5D shows the elongation die with a rectangular shape in an entry region with clear corners in an exit according to the proposed principle;

FIG. 5E shows the elongation die with a rectangular shape in an entry region with clear corners in an exit in which the edges are rounded according to the proposed principle;

FIG. 6A depicts an example method for producing a textured material according to the proposed principle;

FIG. 6B depicts a second example method for producing a textured material according to the proposed principle; and

FIG. 7 shows a detail from a simulation for illustrating transverse elongational stresses.

### DETAILED DESCRIPTION

The following embodiments and examples show various aspects and combinations thereof according to the proposed principle. The embodiments and examples are not always to scale. Similarly, various elements may be shown in enlarged or reduced form in order to highlight individual aspects. It is naturally understood that the individual aspects and features of the embodiments and examples shown in the drawings can be readily combined with each other without thereby affecting the principle of the present disclosure.

In addition, the individual figures, features and aspects are not necessarily shown in the correct size, and the proportions between the individual elements do not fundamentally have to be correct either. Some aspects and features will be highlighted by showing them in enlarged form. However, terms such as “top”, “above”, “bottom”, “below”, “larger”, “smaller” and the like are shown correctly in the drawings in relation to the elements. It is thus possible to derive such relationships between the elements from the drawings.

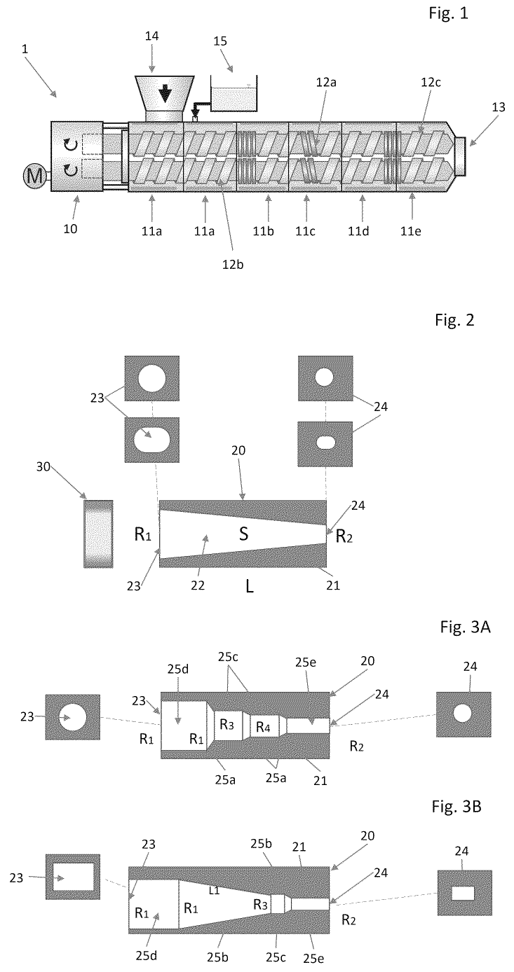

FIG. 1 shows part of an extruder arrangement according to the proposed principle. The extruder arrangement is designed with a mixing extruder 1 having a twin screw drive in which the fed material is kneaded by two screw drives and driven forward in the direction of an exit of the mixing extruder. For this purpose, the mixing extruder 1 includes a motor having a transmission 10 to which the two screw drives are anchored. Connected thereto are multiple sections 11a, 11b, 11c, 11d and 11e of the mixing extruder.

The respective sections are mechanically tightly interconnected by way of flanges or in some other way. In this way, the mixing extruder shown can be either lengthened by adding individual sections or shortened by taking away individual sections. Correspondingly, the screw sections 12a, 12b and 12c are also designed to also be able to be lengthened or shortened by adding or removing individual screw elements.

Specifically, the mixing extruder 1 according to the proposed principle includes two entry sections 11a with associated screw elements 12b. The entry sections 11a each have an opening for feeding the base mixture and water. Specifically, in the embodiment shown, the base mixture is fed via a hopper 14 into a first section 11a of the mixing extruder 1. Subsequently, the water is also added via an inlet 15, such that the two first extruder sections 11a serve especially for first mixing for forming a dough from the water and the fed base mixture.

Connected to the first sections 11a are a multiplicity of further sections 11b, 11c and 11d which are filled with different screw elements 12a that vary. As can be seen in the illustration of FIG. 1, the screw elements serve not only to propel the dough, but also to knead the dough under increased pressure and temperature.

For this purpose, the individual sections are equipped with multiple heating elements (not shown here) which are separately controllable independently of each other. This means that different temperature profiles and thus different temperatures of the propelled dough can be set in the individual sections 11a to 11e. Furthermore, the individual screw elements in the respective sections are also different. Some screw elements serve for kneading the material composed of the base mixture and the fed water in order to thus prepare a dough having a continuous phase. At the same time, kneading and further propulsion of the fed base mixture in these regions increase the pressure up to between 15 and 20 bar. Moreover, further screw elements may also be provided with feeds for gases that serve for feeding a loosening gas to the dough during kneading. The fed gas is bound owing to the pressure in the screw part of the extruder. Feeding is carried out under feedback control and at one or more points during kneading in order to achieve a uniform distribution of the gas in the volume of the dough.

In the event of a simultaneous increase in temperature or a high temperature, for example in the range from 120° C. to 160° C., and a pressure of multiple bar, polymerization of the protein mixture with the water and the further constituents occurs, such that a highly viscous gel-like material is formed. It is kneaded by the individual screw elements 12a in different ways and is driven gradually up to an exit section 11e of the mixing extruder 1.

The exit section 11e of the mixing extruder 1 has, on the exit side, a slightly conical profile with an expulsion zone 13, connected to which, either directly or via an intermediate piece, is an elongation die according to the proposed principle. It is, however, not shown for the sake of clarity, but is explained in the further FIGS. 2 to 5B in a few exemplary embodiments. The dough material present in this exit section is thus pressed under high pressure in the range of multiple bar, for example up to 25 bar, through the expulsion zone into the elongation die, where it is subjected to elongational shaping through uniform propulsion.

FIG. 2 shows such an embodiment of an elongation die according to the proposed principle to explain some aspects of the present disclosure. The elongation die 20 includes an elongation body 21 having an entry region 23 and an exit region 24. The entry region 23 has a diameter or area that is distinctly greater than the diameter or area of the exit region 24. The shape of the entry region 23 and of the exit region 24 may be different, for example, as shown here in FIG. 2, either completely circular, or elongated with rounded ends or elongated in the form of an ovoid.

The entry region 23 is either directly connected to the expulsion zone of the mixing extruder 1 or connected to the expulsion zone 13 via a tubular intermediate piece 30. In the present exemplary embodiment, the elongation die includes an interior which is referred to as the elongation section 22 and is distinguished by a cross-section that continuously tapers at the same gradient over the length L of the elongation die. In other words, the diameter (or radius) R₁ and the respective area in the entry region 23 is continuously reduced over the length of the elongation die up to the cross-section R₂ and the respective area of the exit section 24. In the cross-sectional view of the die 20 shown here, the tapering part thus forms a parallelogram with the two parallel sides corresponding to the entry section 23 and the exit section 24. When viewed three-dimensionally, a truncated cone is seen, and the respective bases or end faces, as shown, can have either a circular shape or a shape having rounded ends with a conical inlet.

The length L of the elongation die is at least three to four times as long as the diameter R₁ in the entry region. The tapering cross-section here causes, at a constant mass flow rate, a continuous increase in the flow velocity of the dough during propulsion through the elongation die 20. In the exemplary embodiment, the flow velocity also increases uniformly owing to the uniformly decreasing cross-section.

In order to achieve a constant mass flow rate, this means that the flow velocity is thus dependent on the radius of the entry region and the exit region or on the areas thereof. For example, if the entry region has an area three times as large as the area of the exit region, the flow velocity in the exit region must also accordingly be increased by a factor of three in order to ensure the same mass flow rate.

Owing to the increasing flow velocity, the propelled dough material is elongated parallel to the elongation in the direction of propulsion. With the pressure remaining high at above 7 bar and with the high temperature in the elongation die in the range of above 100° C., this results in the formation of elongated fibrous structures. The uniform taper, which can be controlled in particular by setting the length of the elongation die and also the entry cross-section and the exit cross-section, avoids wall slip and also a shear stress that leads to cracking of the propelled material.

Furthermore, in a further consideration, the coating of the inside of the elongation die may also be provided with a material particularly low in static friction. Besides stainless steel, which is used, inter alia, in food production, another possibility is a plastic such as Teflon. It is particularly low-friction, and so the edge of the propelled dough material is exposed to a shear stress that is greatly reduced or barely present. As a result, long fibers are produced in the dough material along the direction of propulsion.

Depending on the proteins used and on the base mixture for the extrudate, different elongational stresses are necessary in order to avoid material fracture. Similarly, it may be necessary to allow the propelled material to “rest” somewhat after elongation, so that the fibers can be aligned. Accordingly, the elongation dies may also be designed differently with multiple sections. FIGS. 3A and 3B show two such exemplary embodiments, in which the elongation die is formed of various rest sections and sections with elongational shaping.

FIG. 3A shows an elongation die 20 comprising a die body 21 having, on the entry side, a round entry region 23 and, on the exit side, a correspondingly round exit cross-section 24. In this exemplary embodiment, the diameter R₁ of the entry cross-section is approximately four times as large as the diameter R₂ of the exit cross-section 23. This means that the area of the entry section given by R₁²π=(8R₂)²π is thus approximately 16 times as large as the area of the exit section. Therefore, the flow velocity at the exit must also be approximately 16 times as high as at the entry to the elongation die in order to ensure the same mass flow rate.

The elongation die of FIG. 3A includes multiple sections in its interior. On the entry side is a first section 25d which is substantially cylindrical and in which the area of the entry cross-section remains constant over the length of the section 25d. Connected thereto is a first elongation section 25a in which the area of the entry cross-section R₁ is reduced to a smaller area of the cross-section R₃. In said first elongation section, the flow velocity is thus increased while the mass flow rate remains unchanged, and the propelled dough is subjected to a first elongational stress. The area in the exit region of the first elongation section is approximately ¼ of the area of the entry region 23, and the flow velocity will therefore quicken fourfold.

Thereafter, the dough elongationally shaped in this manner is propelled through a further, second cylindrical section 25c. In this section, the diameter and thus also the cross-sectional area and therefore the flow velocity are again constant, such that the dough in this section undergoes a certain rest phase during propulsion.

Connected thereto is a second elongation section 25a in which the entry-side diameter R₃ and thus the area is reduced again to the exit-side diameter R₄. This reduction is somewhat lower, such that the flow velocity is not excessively increased, in contrast to the first elongation section, but is only doubled for example. Also connected thereto is a further rest section 25c, followed in turn by a last elongation section 25a. Therein, the entry-side diameter R₄ is now narrowed to the exit-side diameter R₂, and the flow velocity increases again somewhat while the mass flow rate remains unchanged.

Arranged on the exit side is now a further rest section 25e of the elongation die 20, in which the propelled elongationally shaped material is further propelled. The section 25e forms the end section, and the material passes out of the die at the exit 24 of said end section.

The elongation sections 25a present here are each designed with a different gradient, with the first elongation section on the left-hand side having the greatest reduction in the diameter (from R₁ to R₃) and thus its cross-sectional area. Accordingly, the flow velocity increases particularly greatly here as well, whereas in each of the following elongation sections, it increases somewhat less (e.g., it increases by a factor of 4 in the first elongation section and then by a factor of two in each of the subsequent elongation sections). The different sections 25d, 25c and the exit section 25e serve especially to ensure that the propelled dough can rest between the individual elongation sections and that no further elongational stress is exerted thereon.

In this connection, it may be convenient to coat the insides of the elongation sections with a suitable material, such that the friction of the dough on the inside of the elongation sections, or the adherence thereof thereto, is further reduced. Especially in the region of the tapered sections, this further reduces possible shear forces, such that only the elongational stress due to the increasingly smaller cross-sectional area acts on the propelled dough.

FIG. 3B shows a further embodiment of such an arrangement, in which the elongation sections, in contrast to the exemplary embodiment of

FIG. 3A, are distinctly extended compared to the rest sections. In the exemplary embodiment, the entry region 23 and also the exit region 24 of the elongation die are moreover no longer circular, but rectangular. In this connection, other entry cross-section shapes and exit cross-section shapes are, however, also possible; furthermore, the shape of the entry cross-section may also differ from the shape of the exit cross-section, such that there is a corresponding change in shape over the course of the elongation sections or the rest sections. This change is configured in such a way that the change in shape exerts as few shear forces as possible on the dough material during propulsion of the dough and that, instead, it is mainly subjected to elongational shaping.

The entry section 25d of the elongation die 20 in FIG. 3B is followed by a conical and tapered first elongation section 25b. Therein, the exit diameter R₃ is approximately a third as large as the entry diameter R₁. The first elongation section 25b is formed with a continuous taper in the direction of the exit region 24 and has a length L1 which is greater than the first rest section 25d in the entry region of the elongation die, and greater than a second rest region 25c following the exit of the first elongation section. It is short, with only one fifth to one quarter of the length of the elongation section 25b, and then passes into a second, shorter elongation section 25b. On the exit side, this elongation is in turn connected to a further rest section 25e, which also forms the exit region 24 at the same time.

The three exemplary embodiments show that, depending on what is implemented, the length of the elongation sections can differ compared to possible rest sections. The taper in the respective elongation sections is dependent on the extrudate used and the ability thereof to form long-fiber structures when an elongational stress occurs.

If the extrudate has a relatively low viscosity, it is convenient to reduce the cross-sectional area over a relatively long stretch and thus subject the extrudate to only low elongational stresses, so that the propelled extrudate does not separate and lead, for example, to wall slip or warping. Extrudates of dough of relatively high viscosity, on the other hand, can undergo stronger elongational shaping without wall slip occurring. Accordingly, relatively short elongation sections or elongation sections with a relatively strong taper could be provided here, such that the flow velocity is increased while the mass flow rate remains unchanged. Rest sections between individual elongation sections serve to relax the propelled extrudate again somewhat and thus prevent separation of the extrudate and the production of shorter fibers.

In some aspects, the material should exit as a textured material, and the textured material should have only a small volume at the exit in question as a single strand. This is especially the case if the extrudate travels at an excessively large volume and at a corresponding elongational stress, thus leading to wall slip or warping. This can occur if elongational shaping becomes great at the edge of the elongation die, but is still too small inside the propelled extrudate material. In the case of the laminar flows present here, shear forces, which impair the formation of long fibers, can also occur, especially in the interior.

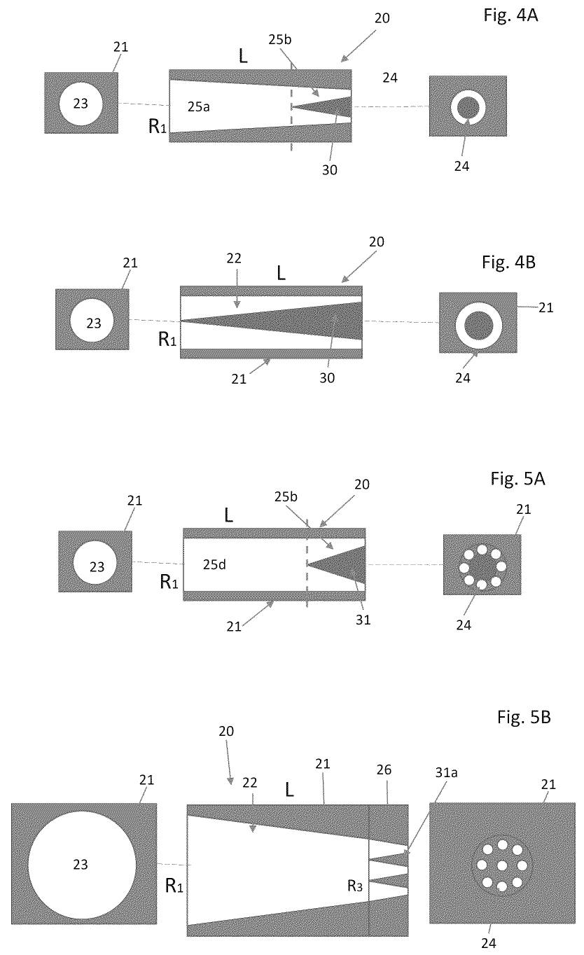

In relation to this, FIGS. 4A and 4B show an exemplary embodiment for preventing such separation, in which the elongation die 20 has a conical body 30 in the exit region 24. Said conical body is in the form of a cone, the frustum of which ends with the exit region 24 and the tip of which points toward the entry region 23 with its diameter R1.

In the exemplary embodiment of FIG. 4A, the cone is designed in such a way that the cone tip thereof ends within the elongation die. In other words, the elongation die is divided into two sections. The inside of the elongation die is designed in such a way that the lateral walls of the elongation die taper continuously over the entire length L at a constant gradient. A second region 25 B adjacent to the first section 25a contains the cone 30. The gradient dx/dy is defined as the decrease in diameter toward the exit region.

The gradient of the cone 30 toward the exit region 24 is slightly greater than the corresponding taper of the inner surfaces of the elongation die 21. Thus, in this exemplary embodiment, a greater elongational stress is built up along the inside along the cone surface than correspondingly on the exit side. As a result, the extruded material moving along the cone surface experiences a slightly greater elongational stress than the material on the other side. The first section 25a is, however, of relevance here; therein, the extrudate as volume material is elongationally shaped especially in its edge region, whereas an interior of this material only undergoes greater shaping by the cone surface of the cone 30 during propulsion.

What is therefore achieved by this arrangement is that the elongational stresses are substantially identical on both sides of the extrudate along the inside of the elongation die and along the cone surface of the body 30.

In an alternative embodiment, the cone tip may be shifted toward the entry region, such that the overall gradient of the cone surface is lower. In a corresponding design, the rising inside of the elongation die and the gradient of the cone surface can there be correspondingly matched to each other.

In a further exemplary embodiment, the tip of the cone body 30 is in the same plane of the entry region 23 with its diameter R₁. This embodiment is shown in FIG. 4B by way of example, and the inside of the elongation die 20 is now formed by a tube having a constant cross-section. The elongation of the dough is now produced by the gradient of the cone body 30 (i.e., the increasingly larger cross-section of the cone body) over the length of the elongation die. In this exemplary embodiment too, the coating of the cone body 30 may be different from the coating of the inside of the elongation die 20, such that wall slip and shear forces occurring during movement are reduced as far as possible.

At the exit of the elongation die in both exemplary embodiments may be arranged a blade or similar mechanical device which slices the circularly expelled textured material and carries it further along a conveyor belt.

The ring diameter in the exit region is dependent on the base area of the cone body and on the inner diameter of the particular elongation die 20. With a mass flow rate that remains unchanged, the result is therefore an increase in the flow velocity and a resulting elongational stress which is substantially dependent on the area of the exit side of the elongation die in relation to the area of the entry side of the elongation die.

In some further aspects, it is conceivable to press out the composition material not as a complete ring or as a complete material, but in the form of multiple noodle-like strands. This has the advantage of increasing the total surface area of the pressed-out material in relation to the volume compared to the other embodiments.

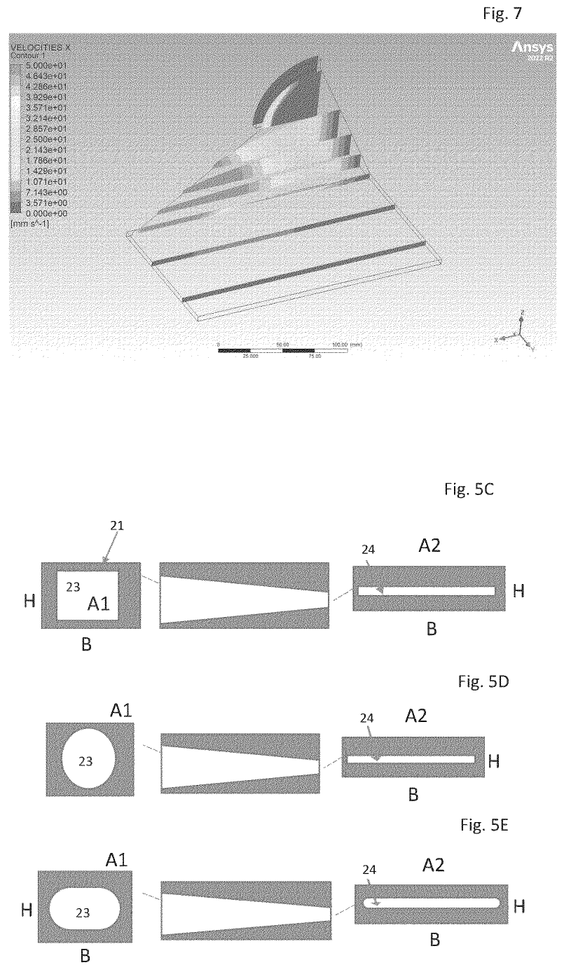

FIGS. 5A and 5B each show such an embodiment. In FIG. 5A, the entry side of a first section 25d is connected to the expulsion zone of the mixing extruder. The entry section 25d has a uniform diameter or cross-sectional area up to a second section 25b. Introduced therein is a conical body 31, the tip of which corresponds with the interface between the two sections 25d and 25b. The conical body 31 opens toward the exit side 24, and here too, like in sub-FIG. 4A, openings are present in cross-section between the inside of the elongation die 20 and the conical body 31. In plan view, said openings are implemented by multiple circular exit openings 24 that are relatively small. In this way, the advanced extrudate is elongated in the region of section 25b by the gradient of the cone body 31 and then pressed through the multiplicity of circular openings 24.

FIG. 5B shows a further embodiment in which the cone body 31 is replaced by a more complex shape 31a. Furthermore, the entry-side section 22 has a tapering cross-section from the entry cross-section R₁ to the section cross-section R₃, which is followed by the body 31a. Here too, multiple circular exit openings through which the material passes are provided in the region 24. The elongational shaping in this second section 26 is increased owing to the additional body 31a, and the material elements of the propelled extrudate that are subjected to elongational shaping are especially also those which are arranged centrally in the first section 22 in the middle of the extrudate and thus experience only slight shaping.

The various elongation dies of the shape presented here are suitable for producing longitudinal fibrous structures in an extrudate and providing it as textured material for further processing.

The various shapes and also the intensity of elongational shaping can be adjusted by way of an appropriate geometry, based on the length of the elongation die and on the individual cross-section. This makes it possible to texture even materials that tend to separate or break up on excessive elongation.

In this exemplary embodiment, the elongation die is especially distinguished in that its length is greatly increased in relation to its entry or exit cross-section. Moreover, it may include multiple relatively short or relatively long elongation sections and also rest sections in which the propelled dough is not stretched further in the longitudinal direction or only stretched slightly in that direction. Moreover, it is generally possible for the elongation die to include further heating or cooling elements in order to be able to produce different temperatures in the individual sections as well, if necessary.

FIGS. 5C to 5E address a further aspect, namely that, instead of the entry cross-section decreasing uniformly (albeit in sections), the entry is reduced in a desirable direction while being even increased in the other direction in relation to the exit. In this respect, FIG. 5C shows one embodiment in which the entry 23 and its area A1 remains substantially unchanged in relation to the exit region 24 and its area A2, but its shape is altered. Specifically, a square entry region is provided in FIG. 5C. A continuous decrease in height with a simultaneous increasing of width results in an elongated narrow transverse slit in the exit region 24 that is approximately twice as wide as the entry. However, its height has decreased by more than a half.

The elongation die thus leads here to a decreasing height-to-width ratio over the length of the elongation die. For example, the width B can increase by a factor of 3, while the height H decreases by the same factor. However, also possible in this connection are other factors, by which the cross-sectional area of the exit region 24 is also reduced compared to the entry region 23. In the present example of FIG. 5C, the decrease in the height of the die at the exit is much greater than the increase in width. This means that, altogether, the area of the exit is also smaller than the cross-sectional area at the entry. Accordingly, in this exemplary embodiment, the result is not only a transverse flow velocity and thus an elongation of the material perpendicular to the forward direction, but also a longitudinal elongation.

FIGS. 5D and 5E show two further designs, this time with round or oval entry cross-sections. In FIG. 5D, this oval shape in the entry region 23 is transformed to a rectangular shape with clear corners in the exit 24, but in FIG. 5E, the edges are rounded and thus at least roughly retain the same form as in the entry region 23. In this design, the areas of the entry and the exit are identical, such that only transverse flow occurs here, but no longitudinal flow or only very slight longitudinal flow. Accordingly, the material is especially shaped transversely to the direction of propulsion. In FIG. 5E, the areas in turn are different, such that a longitudinal elongation of the material is produced here as well in addition to a transverse elongation.

In all these arrangements, a decrease or change along a first direction (e.g., width of the die) perpendicular to the direction of propulsion is thus effected differently along a second direction (e.g., height H) perpendicular to the direction of propulsion. Accordingly, the nonidentical decrease in the two different spatial directions results in the exertion of not only a longitudinal elongation, i.e., along the length of the elongation die, but also a transverse elongation, i.e., along the width B or height H. The transverse elongations, in turn, differ because the height and width differ. This design thus makes it possible to bring about a longitudinal and transverse elongation in a highly viscous material in a specific manner and with control of their intensity through the geometry of the elongation die.

FIG. 7 shows a simulation illustrating the production of transverse elongational flows by changing the die geometry. The illustration shows a quarter of the die, which for reasons of symmetry is sufficient for the simulation. The direction of propulsion of the highly viscous material is the Y-direction. Lighter colors show a higher flow velocity. The inlet of the die can be seen in the above corner, and the flow velocity is substantially identical there. The inlet geometry of the die defines the total mass flow rate.

Now, it can be seen that the die in the direction of propulsion not only broadens in the X-direction, but also becomes thinner at the same time, i.e., the dimensions in the z-direction are reduced. Put simply, the die becomes not only wider, but also thinner in the direction of propulsion. This transition does not occur on the entire length of the die, but rather in a quite short section approximately corresponding to half or one third of the length of the die. The ratio of the maximum width in the x-direction to the length of the die, i.e., B/L, is approximately 2, i.e., the die is much wider than it is long.

As can be seen, the increase and the decrease in the height of the die increases the flow velocity especially at the edge. An elongational stress substantially perpendicular to the propulsion in the Y-direction is therefore exerted on the viscous material. This elongational stress is therefore referred to as a transverse elongational stress. However, the material does not adhere to the wall, but slides thereon instead. The simulation shows that shear forces that could lead to separation hardly occur.

This transverse elongational stress leads to fiber formation in the highly viscous material, the orientation of which is transverse to the forward direction. Approximately halfway along the entire length, the die has reached its final height (in the Z-direction) and width, such that no further transverse elongational stresses are produced and that uniform propulsion occurs instead. When this material elongationally shaped in this way exits the die, it can be cut along the fiber by mechanical measures, such that pieces of identical width and of differing length depending on the speed of propulsion are produced. Similarly, it is then possible to use, after the transverse die, an extension die that can be used for cooling or for building up pressure. This allows better control of the temperature and pressure of the mass flow.

The dies shown here can be combined as desired with respect to their individual sections, geometries and wall coatings, in order to thus control fiber formation and prepare it for the desired end product. It should be ensured in particular that the material is highly viscous, such that sliding on the lateral walls occurs in particular.

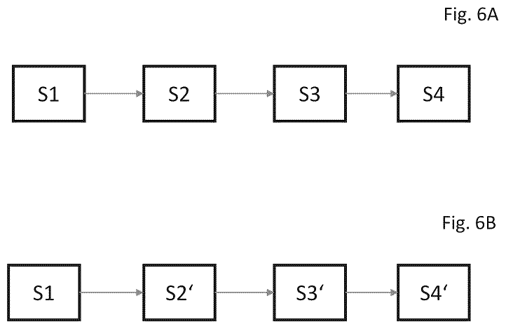

FIGS. 6A and 6B show, by way of example, the steps of a method for producing a textured material according to the proposed principle, as can be prepared, by way of example, with the extruder arrangement and elongation dies shown in the figures. The method takes advantage of the fact that a dough mixture having a relatively low water content leads to an increased interaction between the individual proteins and polymers while the dough is being kneaded in the extruder arrangement, such that the resultant dough has a distinctly increased viscosity. Viscoelasticity can be adjusted by adding sugar and salt, and by a suitable thermomechanical treatment by the proposed extruder arrangement (e.g., the use of a two-axis screw drive). Moreover, the geometries of the elongation die that are presented apply a defined and extended/continuous elongation to an extrudate having specific high-viscosity behavior □ which leads to a very efficient elongation of a multiphase extrudate. Owing to the geometry and to the low static friction due to the coating of the die (depending on the geometry), shearing is reduced, such that fracture of the extrudate during propulsion or wall slip is largely avoided.

In the case of some protein mixtures, strong elongation may also be destructive and cause the fibers formed to fragment when they are exposed to excessive elongation. Since the elongational stress mainly depends on the change in velocity of the mass flow, the intensity and duration of elongation can be easily adjusted by geometry-related factors, and so this method is highly flexible for different protein sources.

FIG. 6A shows a first exemplary embodiment of the proposed method. In step S1, a protein mixture is provided. It includes a protein isolate from wheat and a protein isolate from pea protein. The proportions of the proteins in the respective isolates are approx. 90% by weight, with residual moisture in the range of approx. 5% by weight and other constituents. In this embodiment, there are hardly any plant fibers in the isolates. Approximately equal proportions of the two isolates are mixed and they take up about 55% by weight of the base mixture. Likewise, also added to the mixture are 10% by weight of vegetable oil and salt in the range of 1% by weight and sugar in the range of 5% by weight based on the base mixture. Flavorings and spices are in the range of 2% by weight. The solid and oily constituents thus take up 73% by weight, and the residual moisture in this mixture accounts for approx. 2.7% by weight (55%*0.05%).

In step S2, water is added to the mixture, specifically in the range of 27% by weight, and mixed to form a light dough. Water is thus present in the resultant dough at approx. 30% by weight.

The dough is then kneaded in step S3 under pressure and elevated temperature to form a dough. The dough is kneaded and then propelled a little in sections. In the each section, the temperature is rapidly increased from room temperature to over 100° C., and then held within a range of 130° C. for the remaining kneading and propulsion steps. The pressure here is above 5 to 6 bar.

In the expulsion zone of the mixing extruder, the material is transferred directly into an elongation die. The elongation die includes a short entry section in which the cross-section remains substantially unchanged, an elongated elongation section and an exit section.

In this embodiment, in step S4, the material is subjected to a longitudinal elongation at a temperature of approx. 125° C., the stress of said elongation resulting from a continuous reduction of the entry cross-section to the exit cross-section. In terms of area, the entry cross-section is larger than the exit cross-section by a factor of 8. Elongation is effected over a stretch which is greater than the diameter of the entry cross-section by a factor of 3 to 4. Since the mass flow rate is constant, the flow velocity therefore likewise changes by a factor of 8 over this stretch, as a result of which the extrudate is elongated, especially in its length. In the middle section of the elongation die, static friction is reduced by a suitable coating, such that the propelled extrudate does not stick, and such that relatively large shear forces that could lead to wall slip or extrudate fracture do not occur.

The temperature is not substantially changed during elongational shaping, i.e., at the end of the elongation die, the textured material has a temperature of approximately 125° C. At the exit, rapid expansion occurs owing to the pressure drop. This produces a porous structure of the textured material without destroying the long-fiber structure produced by the elongational stress.

Another example of a method for producing a textured material having a fibrous structure of a length that can be greater than 10 cm is shown in FIG. 6B.

Here too, a protein mixture is provided in step S1. In the example, it includes a protein concentrate composed of pea protein. The pure protein content in the concentrate is in the range of 55% by weight. The remaining 45% by weight in the concentrate is divided into a residual moisture content of 15% by weight, vegetable oils and fats at about 10% by weight and starch in the range of 10% by weight. The remaining 10% by weight are fibers and other residual plant constituents, such as salts and minerals.

For the base mixture, the protein concentrate at proportion by weight of 75% by weight is mixed with 25% by weight of water. Further components are not added in this example. This results in the following proportions for the base mixture: 41% by weight of pure protein, 36% by weight of water, 7.5% by weight of oils and fats, 7.5% by weight of starch and approx. 7.5% by weight of fibers.

In step S2□, this substantially dry mixture is added to a mixing extruder and, under pressure and elevated temperature, the water is slowly added in different successive sections. In other words, the water is not added at once, but in multiple parts during the kneading operation. The water is already heated during addition, such that no temperature drop or only a slight temperature drop occurs and the dough is kept at a high or rising temperature during propulsion. The maximum temperature during the kneading operation is in the range of approx. 145° C.

In step S3, the extrudate is subjected to an elongational stress. The extrudate is propelled without elongational stress in sections and elongationally shaped in sections. The latter is effected by increasing the flow velocity of the extrudate while the mass flow rate remains unchanged. The sectional elongational shaping and the resting sections reduce transverse stresses or warping in the extrudate, such that particularly long fibers are formed. The length of propulsion in which the flow velocity is increased sectionally is distinctly greater than the diameter of the entry cross-section. In addition, in this design, the increase in flow velocity in the tapering sections of the elongation die varies. Specifically, the flow velocity is initially only slightly increased, but is further increased during propulsion. This prevents fracturing in fiber formation.

In section S4, the product is suddenly relaxed at the exit. At the same time, however, the temperature does not drop abruptly, but rather slowly to below 100° C. As a result, some of the water bound in the textured material evaporates, which leads to pore formation. In further downstream processes in step S4, the textured material thus prepared is further processed.

In another alternative example not shown in the drawings, a protein mixture composed of a fava bean concentrate and a wheat protein isolate is produced by mixing them at the proportions of 70% by weight and 30% by weight. Besides a protein content of 45% by weight, the fava bean concentrate also contains starch and sugar at 25% by weight, residual moisture at 10% by weight and fibers, oils and other constituents at 20% by weight. The wheat protein isolate has a protein content of 93%; 3% by weight is residual moisture, 2% by weight is starch, and the remainder is oils and fats. The abovementioned mixture results in protein contents in the range of 59.4% by weight, sugar and starch in the range of 18% by weight, a residual moisture content of 8% by weight, and 15% by weight of remaining constituents.

This material can now, for example, be mixed with water to produce the base mixture, with 80% by weight of this mixture receiving 20% by weight of water. This results in, for example, a total content of 47.5% by weight of proteins and 26.4% by weight of water. The remainder is made up of 14% by weight of starch and sugar and also the other constituents. This base mixture is further processed by the proposed method.

The methods specified herein produce a textured material having a moisture content that is lower than the water content in the base mixture during kneading of the dough. The reason for this is the water loss during expansion at the exit of the elongation die after or during the step of elongational shaping, especially when holding the temperature of the extrudate and the pressure above the vapor pressure of water at this temperature.

1. A method for producing a textured material, comprising the steps of:
providing a protein mixture comprising at least a first protein mixture including a legume protein mixture or a wheat protein mixture, at a proportion by weight of between 40% by weight and 90% by weight based on a base mixture;
supplying water at a proportion by weight of between 10% by weight and 45% by weight based on the base mixture to shape a dough;
extruding the dough up to a maximum temperature of between 110° C. and 160° C. to form a highly viscous material; and
performing elongational shaping of the extrudate at a temperature of higher than 100° C. by propulsion of the extrudate through an uncooled elongation die, the geometry of which changes over the length in such a way that a longitudinal and/or transverse elongational stress is produced on the material, an area of the entry cross-section of the elongation die being greater than an area of the exit cross-section and the length of the elongation die being greater than a maximum diameter of the entry cross-section, a temperature of the extrudate at the exit of the elongation die being higher than 100° C., a stretch of propulsion of the extrudate being greater by at least a factor of 3 to 7 than one from the maximum diameter of the entry cross-section and the maximum screw diameter.

2. The method according to claim 1, wherein:
the water is supplied to the protein mixture in an extruder; or
a gas-producing agent, in particular in solid form, is added to the base mixture, in particular comprising sodium hydrogencarbonate, before water is supplied.

3. The method according to claim 1, wherein the step of extruding comprises a step of:
kneading the supplied protein mixture and water at a rising temperature up to the maximum material temperature; or
adding gas while the supplied protein mixture and water is being kneaded.

4. The method according to claim 1, wherein the maximum material temperature is in the range between 115° C. and 135° C. between 120° C. and 145° C.

5. The method according to claim 1, wherein the step of extruding the dough is carried out at a pressure of 5 bar to 150 bar.

6. (canceled)

7. The method according to claim 1, wherein the step of performing elongational shaping comprises:
increasing the flow velocity at least in one direction, or
during elongational shaping, the extrudate is elongationally shaped longitudinally and optionally transversally and, at the same time, propelled.

8. The method according to claim 1, in which the step of performing elongational shaping comprises:
performing sectional elongational shaping at temperatures of higher than 100° C. by propelling the extrudate, such that a flow velocity is increased; or
propelling the extrudate at a substantially constant flow velocity, a time at a substantially constant flow velocity being greater than a time during which the flow velocity is increased; or
propelling the extrudate, in which forces of differing magnitude, each perpendicular to the direction of propulsion, are exerted on the material during propulsion; or
in which the extrudate is elongated more strongly along a first direction perpendicular to the direction of propulsion than along a second direction perpendicular to the direction of propulsion and first direction; or
increasing an average flow velocity of the extrudate within the die at least twofold.

9. (canceled)

10. The method according to claim 1, wherein the shear stress is changed at least in two successive sections during propulsion.

11. The method according to claim 1, further comprising:
cooling to a temperature below 100° C. to form the textured material after the step of performing elongational shaping.

12. An extruder arrangement comprising:
a mixing extruder comprising an inlet zone for supplying a base mixture containing at least one protein mixture and water, a mixing zone and an expulsion zone;
the mixing extruder being designed to produce a temperature rise over the zones up to a maximum temperature of between 110° C. to 160° C.;
an uncooled elongation die connected to the exit zone of the mixing extruder and having a length, an entry cross-section and an exit cross-section, the exit cross-section being shaped differently from the entry cross-section, such that a longitudinal or transverse elongation is produced on the material;
an area of the entry cross-section of the elongation die being greater than an area of the exit cross-section and the length of the elongation die being greater than a maximum diameter of the entry cross-section; and
a stretch of propulsion of the extrudate being greater by at least a factor of 3 to 7 than one from the maximum diameter of the entry cross-section and the maximum screw diameter, and the elongation die being configured to bring about a temperature of the extrudate of higher than 100° C. at the exit.

13. The extruder arrangement of claim 12, wherein:
an inside of the elongation die is coated with a fluoropolymer; or
an inside of a first section of the elongation die comprises a first material, and an inside of a subsequent second section of the elongation die comprises a second material different from the first material.

14. The extruder arrangement of claim 12, wherein the maximum temperature in at least one of the zones is in the range between 115° C. and 135° C. or between 120° C. and 145° C.

15. The extruder arrangement of claim 12, wherein the elongation die is designed to hold a temperature of the propelled material in the range between 110° C. to 160° C.

16. (canceled)

17. The extruder arrangement of claim 12, wherein the elongation die has a continuous decrease in inner diameter from the entry cross-section to the exit cross-section.

18. The extruder arrangement of claim 12, wherein:
the elongation die comprises at least one section in which a reduction in diameter along a first direction perpendicular to the direction of propulsion is greater than a reduction along a second direction perpendicular to the first direction and direction of propulsion; or
the elongation die comprises at least one section in which an increase in diameter is effected along a direction perpendicular to the direction of propulsion;
the elongation die comprises at least one first section having a constant cross-sectional area, at least one second section having a decreasing cross-sectional area and at least one third section having a constant cross-sectional area; or optionally
a material of a section having a constant cross-sectional area is different from a material of a section having a decreasing cross-sectional area.

19. The extruder arrangement of claim 18, wherein the at least one first section has the entry cross-section and the at least one third section has the exit cross-section.

20. The extruder arrangement of claim 12, wherein the exit cross-section, in plan view, has the shape of a circular ring, an inner part surrounded by the circular ring being formed by a body having a cone shape, tapering toward the entry cross-section.

21. The extruder arrangement of claim 12, wherein the exit cross-section, in plan view, has multiple openings of identical cross-section, arranged around an inner part, the inner part having a body tapering toward the entry cross-section.

22. The extruder arrangement of claim 21, wherein the inner part is arranged with a central opening, the cross-section of which is optionally different from the cross-sections of the openings surrounding the inner part.

23. The extruder arrangement of claim 12, further comprising:
a cooling element having a cooling die, connected to the exit of the elongation die and configured to cool the elongationally shaped highly viscous material to below 100° C.
